(19) United States
(12) Patent Application Publication
(10) Pub. No.: US 2006/0213066 A1
(43) Pub. Date: Sep. 28, 2006

(54) Steel strip cutters

(76) Inventor: Hsiu-Man Yu Chen, Taichung (TW)

Correspondence Address: TROXELL LAW OFFICE PLLC;SUITE 1404, 5205 LEESBURG PIKE, FALLS CHURCH, VA, 22041, US

(21) Appl. No.: 11/086,349

(22) Filed: Mar. 23, 2005

(51) Int. Cl. B26B 13/00

(52) U.S. Cl. 30/229

(57) ABSTRACT

Steel strip cutters include a first and a second cutting body and two handles. The first cutting body has a hole for the second cutting body to extend through. A cutting edge is formed at one side of the hole, and a lower step is formed beside the cutting edge. Two pressure-enduring edges are formed on one side of the hole and on the lower step. The second cutting body has a recess in the bottom, and a cutting edge is formed at one side of the recess. Two clamping edges are formed beside the recess and the bottom edge of the outer side, respectively. When used for cutting steel strips, cutting edges of the two cutting bodies carry out a cutting action through a user pressing the handles inward and the clamping edges clamp the two ends of the cut steel strip, to thereby prevent the cut ends of the steel strip from bouncing resulting in greater safety for a user.

### BACKGROUND OF THE INVENTION

1. Field of the Invention

This invention relates to a steel strip cutter, particularly to one used for cutting steel strips and clamping two cut ends of the steel strip so as not to allow two ends of a steel strip bounce or flip when cut and thereby hurt a user or other persons around.

2. Description of the Prior Art

Conventional steel strip cutters 10 shown in FIG. 1 are composed of two cutting bodies 11 pivotally combined together, a cutting blade 111 formed in a front end of each cutting body 11, a pivotal member 112 formed in a rear end for pivotally connecting with two handles 12, which have a lower section a little below the pivotal members 112 also pivotally connected with each other. The steel strip cutters cut a steel strip with the two cutting blades 111 using the lever principle by pressing the handles inward with a user's hands.

However, the steel strip cut by conventional steel strip cutters 10 may have the cut two ends bounce, jump or flip around at the very moment when the ends are cut off, resulting in the danger of hurting the user and persons around because of the fast movement of the steel strip. So the conventional steel strip cutters are not safe to use.

### SUMMARY OF THE INVENTION

This invention has been devised to offer steel strip cutters, which can be used without any danger of the two cut ends of a steel strip bouncing around, thereby safeguarding a user and persons around.

The steel strip cutters are composed of a first and a second cutting body and two handles pivotally combined with each other. The first cutting body has a hole for the second cutting body to extend through so that the first cutting body and the second cutting body can pivot with respect to one another. The first cutting body is provided with a cutting edge at one side of the hole and a lower step at the outer side of the hole and two pressing edges at the other side of the hole and on the lower step. The second cutting body has a recess in the bottom and two clamping edges. When used to cut metal, the two pressing edges and the two clamping edges define two gaps. Then the cutting edges of the first and the second cutting body perform a cutting action when the handles are pressed inward to each other. And the two ends of a steel strip cut are respectively clamped in the two gaps, effectively preventing the cut ends from bouncing around and endangering a user or persons around.

### BRIEF DESCRIPTION OF DRAWINGS

This invention will be better understood by referring to the accompanying drawings, wherein:

FIG. 1 is a perspective view of conventional steel strip cutters;

FIG. 2 is a perspective view of steel strip cutters in the present invention;

FIG. 3 is a partial exploded perspective view of the steel strip cutters in the present invention;

FIG. 4 is a front view of the steel strip cutters in the present invention;

FIG. 5 is a front cross-sectional view of a first and a second cutting blades having a steel strip placed between them but not yet cut in the present invention; and,

FIG. 6 is a front cross-sectional view of the steel strip cut off by the first and the second cutting blades in the present invention.

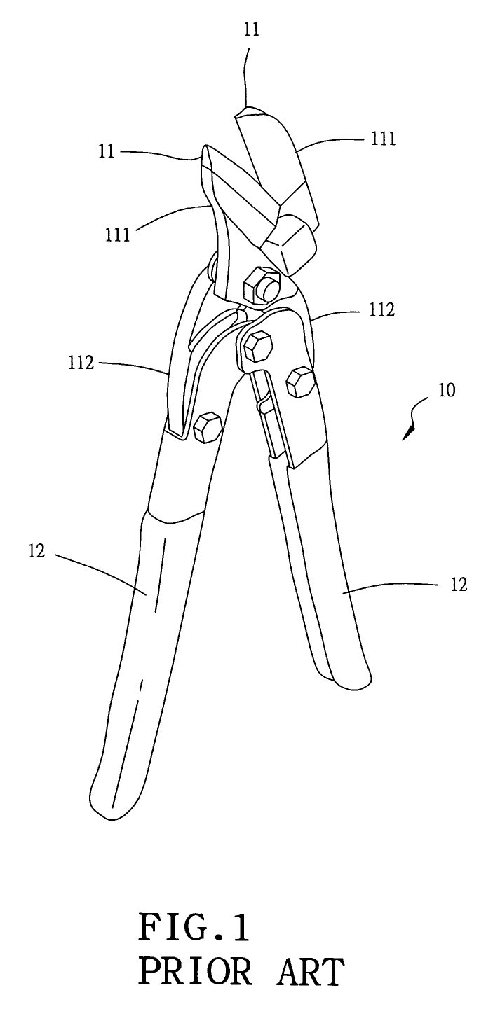

### DETAILED DESCRIPTION OF THE PREFERRED EMBODIMENT

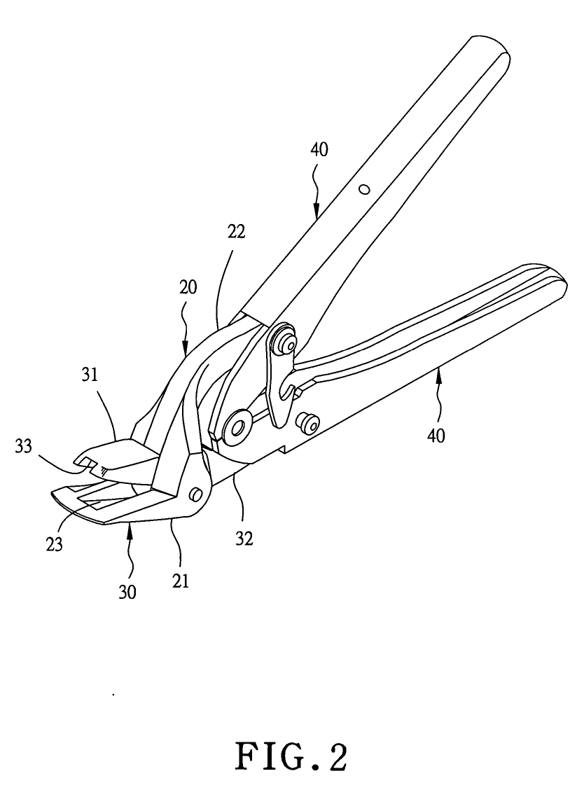

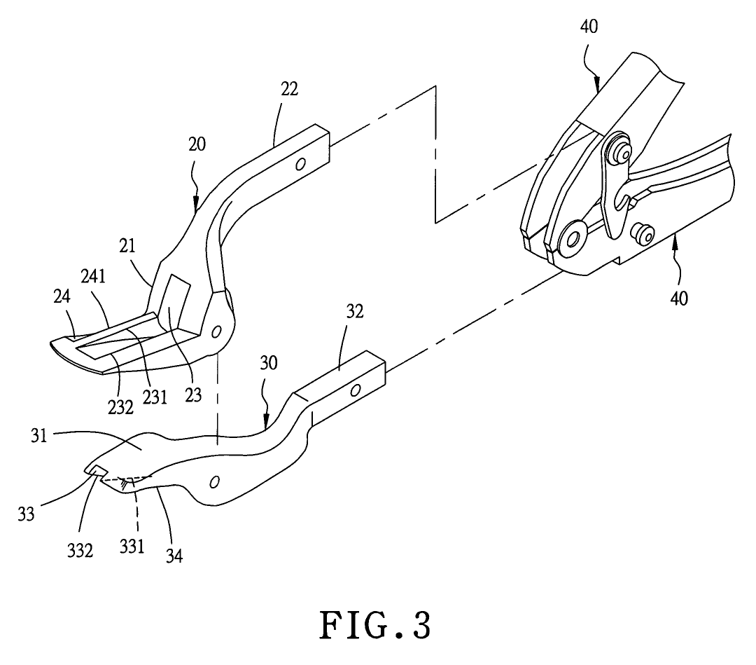

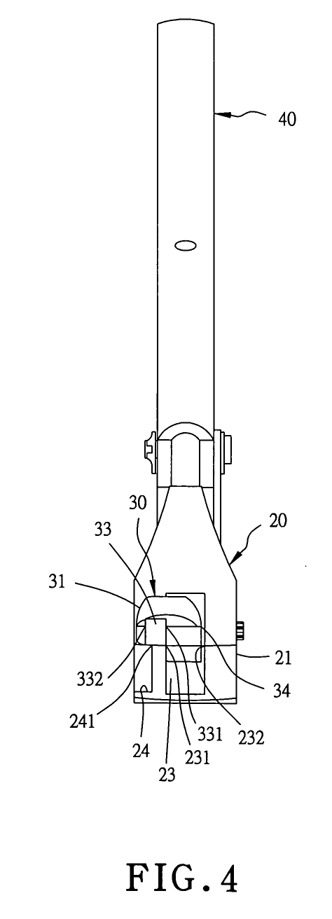

A preferred embodiment of a steel strip cutters in the present invention, as shown in FIGS. 2, 3 and 4, includes a first cutting body 20, a second cutting body 30 and two handles 40 pivotally combined with each other and then with the two cutting bodies.

The first and the second cutting body 20 and 30 respectively having a cutting blades 21 and 31 formed in the front end, and a pivotal member 22 and 32 forming a rear end pivotally connected with upper ends of the handles 40. In use, the two handles 40 are clamped to pivotally move inward for closing up the two cutting bodies 20 and 30 and perform a cutting operation.

The first cutting body 20 has a hole 23 formed in the intermediate portion and extending from the pivotal member 22 to the cutting blade 21, and the hole 23 has a cutting edge 231 formed on one side slanting down to the front and a pressure enduring edge 232 formed on the opposite side to the cutting edge 231. Further, the cutting blade 21 has a lower step 24 at the outer side of the cutting edge 231 and a pressure enduring edge 241 formed on top of the lower step 24.

The second cutting body 30 is located to extend through the hole 23 of the first cutting body 20 the second cutting body 30 has a recess 33 in the bottom facing the section between the hole 23 and the lower step 24, a cutting edge 331 formed at one side of the recess 33 to correspond to the cutting edge 231 of the first cutting body 20 for carrying out a cutting operation. The recess 33 further has a clamping edge 332 formed at the other side of the recess 33, and the clamping edge 332 and the pressure enduring edge 241 of the first cutting body 20 define a gap of a preset size between them as shown in FIG. 6, for clamping one end of a cut steel strip. The second cutting body 30 further has a clamping edge 34 formed at the bottom of the second cutting body 30, and the clamping edge 34 and the pressure enduring edge 241 of the first cutting body 20 define a gap (b) between them for clamping the other end of a cut steel.

It is important to mention that the gaps (a) and (b) formed between the two pressure enduring edges 232 and 241 of the first cutting body 20 and the clamping edges 332 and 34 can be designed to have different sizes according to the thickness of steel strips to be cut, and preferably the gaps (a) and (b) are a little larger than the thickness of steel strips, Further, the cutting edge 231 of the first cutting body 20 and the two clamping edges 332, 34 are preferably of the same height, and the cutting edge 331 and the two clamping edges 332, 34 are preferably of the same height for smoothly clamping synchronously.

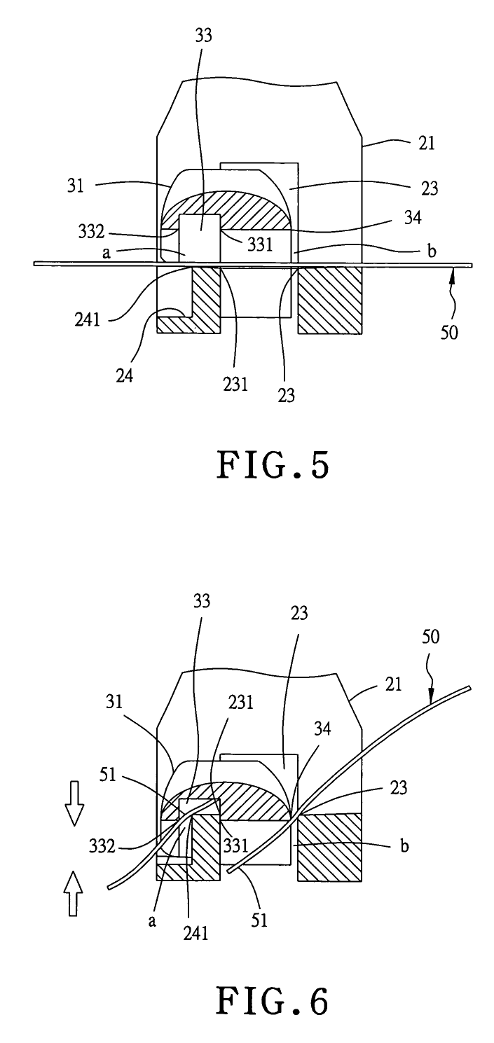

Next, as shown in FIGS. 2 and 5, the method of using the steel strip cutters of the preferred embodiments is almost the same as that of the conventional one; a steel strip 50 is placed in an open space between the cutting blades 21 and 31 of the first and the second butting body 20 and 30, and then the two handles 40 are pressed inward towards each other, letting the cutting blades 21 and 31 perform a cutting action against the portion of the steel strip 50 between the two cutting edges 231 and 331 until the steel strip 50 is completely cut. It is important to note that as shown in FIG. 6, when the two cutting edges 231 and 331 are cutting, the two pressure enduring edges 232 and 241 of the first cutting body 20 and the two clamping edges 332 and 34 may move nearer and nearer to each other, with the two ends of the steel strip 50 being clamped and pressed at the moment of cutting off, so the cut two ends 51 of the steel strip 50 may be securely clamped slantingly in the gaps (a) and (b) between the two pressure enduring edges 232 and 241 and the two clamping edges 332 and 34. As a result, the cut ends do not bounce randomly around and endanger the user and persons around. So the steel strip cutters are quite safe for a worker to use.

While the preferred embodiment of the invention has been described above, it will be recognized and understood that various modifications may be made therein and the appended claims are intended to cover all such modifications that may fall within the spirit and scope of the invention.

1. (canceled)

2. The steel strip cutters as claimed in claim 5, wherein said gaps defined between said clamping edges and said pressure edges are larger than the thickness of steel strips.

3. The steel strip cutters as claimed in claim 5, wherein said cutting edge of said first cutting body is as high as said two pressure enduring edges.

4. The steel strip cutters as claimed in claim 5, wherein said cutting edge of said second cutting body is as high as said two clamping edges.

5. A steel strip cutter comprising:
a first cutting body having a hole in an intermediate portion extending from a pivotal member to a cutting blade, a cutting edge formed to slant forward at one side of said hole, a pressure enduring edge formed at the top of a lower step, said lower step formed at an outer side of said cutting blade, and a recess formed in a lower section of said first cutting body between said hole and said lower step of said first cutting body, a first clamping edge formed at the other side of a bottom surface of said recess, said first clamping edge defining a gap of a preset size between said pressure enduring edge of said first cutting edge for clamping one end of a steel strip cut off during a cutting action;
a second cutting body pivotally connected to said first cutting body, said second cutting body located to extend through said hole of said first cutting body, a second clamping edge formed in the bottom of the outer side of said second cutting body to form a gap of a preset size between said other pressure enduring edge of said first cutting body for clamping the other end of the steel strip cut; and
handles pivotally connected with each other at a point near said two cutting bodies,
wherein said steel strip cutter is configured to prevent the cut ends of the steel strip from recoiling by separating the cut ends and securely holding the one end of the steel strip with said pressure enduring edge of said first cutting body in a laterally shifted position relative to said other end of the steep strip securely held by said pressure enduring edge of said second cutting body.
